(19) United States
(12) Patent Application Publication
(10) Pub. No.: US 2016/0376165 A1
(43) Pub. Date: Dec. 29, 2016

(54) FILTER AS YOU POUR SYSTEM

(71) Applicant: BRITA LP, Oakland, CA (US)

(72) Inventors: Nikhil P. Dani, Pleasanton, CA (US); Jonathan McDonald, Danville, CA (US); Nicole Doan, Danville, CA (US); Jonathan Taylor Wiegele, Venice, CA (US)

(73) Assignee: BRITA LP, Oakland, CA (US)

(21) Appl. No.: 15/039,012

(22) PCT Filed: Dec. 8, 2014
(86) PCT No.: PCT/US14/69064

§ 371 Date: May 24, 2016

Related U.S. Application Data
(63) Continuation-in-part of application No. 14/132,134, filed on Dec. 18, 2013.
(60) Provisional application No. 61/940,101, filed on Feb. 14, 2014.

(51) Int. Cl. C02F 1/00; C02F 1/42; B01D 35/30; C02F 1/28

(52) U.S. Cl. CPC C02F 1/003; C02F 1/283; C02F 1/42; B01D 35/30; C02F 2101/12

(57) ABSTRACT

The invention relates to filter-as-you-pour filtration container systems. Such a system may include a container body defining an internal storage volume for holding water, a lid that may be releasably attachable over the container body, and a filter assembly (e.g., disposed within the container body). The system includes an inlet through which unfiltered water is introduced into the container body, and an outlet through which filtered water may be poured. The filter assembly may be attachable to at least one of the lid or container body, and is disposed relative to the outlet so as to be in a flow stream of the water as the water is poured from the container. The filter media of the filter assembly may comprise an activated carbon fibrous textile material that presents a curved surface to the water. Such systems surprisingly provide for relatively high flow rates (e.g., at least 0.3 GPM).

### CROSS-REFERENCE TO RELATED APPLICATIONS

This application is the National Stage of International Application No. PCT/US2014/069064, filed Dec. 8, 2014, which claims the benefit under 35 U.S.C. 119(e) of U.S. Provisional Patent Application Ser. No. 61/940,101, filed Feb. 14, 2014. International Application No. PCT/US2014/069064, filed Dec. 8, 2014, is a continuation-in-part of U.S. patent application Ser. No. 14/132,134, filed Dec. 18, 2013. The disclosure of each of the above applications is incorporated by reference in its entirety.

### BACKGROUND OF THE INVENTION

1. The Field of the Invention

The present invention is generally directed to filtered pour through container (e.g., pitcher) systems where filtering is achieved as the user pours water from the container.

2. Description of Related Art

Drinking water, such as water from water purification facilities or well water, can contain certain additives or contaminants (referred to herein collectively as contaminants) such as chlorine, chloramines or various organic components. Chlorine is typically intentionally added to water to control microbes. For some, chlorinated water imparts an unpleasant taste or smell. Its presence may also raise health concerns to some consumers.

Existing pour through pitcher systems, such as those available from BRITA, allow a user to fill a reservoir of the pitcher with water, which passes (under influence of gravity) through a filter, which removes contaminants from the water. The filtered water exits the filter into the main body of the pitcher, and may then be poured therefrom, providing filtered water for drinking.

One disadvantage of existing systems is that it may take several minutes for water introduced into the reservoir of such a system to be filtered, and ready for drinking. It would be beneficial to provide systems that might provide filtered water poured from a pitcher where the time required to filter may be reduced.

### BRIEF SUMMARY

In an embodiment, the present invention is directed to a filter-as-you-pour system configured to provide filtered water as water is poured from an outlet of the system. The system may comprise a container body defining an internal storage volume for holding water, a lid, and a filter assembly. The system comprises an inlet (e.g., in the lid or container body) through which unfiltered water may be introduced into the container body, as well as an outlet (e.g., in the lid or container body) through which water within the container body may be poured, the water being simultaneously filtered as it is poured therefrom. The lid may be releasably attachable over the container body, and the filter assembly may be attachable to at least one of the lid or container body. The filter assembly may be configured and arranged so as to be in a flow stream of the water as the water is poured out of the container body through the outlet so that the stream of water exiting the outlet is filtered as it is poured from the container body. The filter assembly may include filter media that comprises an activated carbon textile material that presents a curved surface to the flow stream of water, such that an exit flow rate of water passing through the filter assembly and poured from the outlet is at least 0.3 gallons per minute (GPM).

Another embodiment is directed to a filter-as-you-pour system configured to provide filtered water as water is poured from an outlet of the system, where the system comprises a container body defining an internal storage volume for holding water, a lid that is releasably attachable over the container body, an inlet (e.g., in the lid or container body) through which unfiltered water may be introduced into the container body, an outlet (e.g., in the lid or container body) through which water within the container body may be poured and simultaneously filtered, and a filter assembly attached to at least one of the lid or the container body. The filter assembly is disposed proximate the outlet of the system, so that water in the container body passes through the filter assembly and is filtered only as it is poured out of the container body. In other words, there is no filter in the fill path associated with the inlet of the container body, so that water entering into the container body through the inlet does not initially pass through a filter before entering the container body.

Because such an embodiment includes no filter in the fill path, there is no delay associated with water being introduced into the inlet, and the time that it enters the interior storage volume of the container body. As such, the water disposed within the interior storage volume is unfiltered by the container system, until it exits through the outlet (where it passes through the filter assembly just prior to exiting the outlet). Such a configuration allows for faster filling of the container as compared to existing systems that include a filter within the fill path (e.g., disposed between the inlet and the storage volume). Such embodiments which provide for filtering of the water only as it is poured out of the container body may employ a filter media comprising an activated carbon textile material arranged within the filter assembly so as to present a curved surface to the flow stream of water. This arrangement has been surprisingly found by the present inventors to provide for relatively high flow rates, making it possible as a practical matter to filter the water only on exit (i.e., filter only as-you-pour).

Another embodiment of the present invention is directed to a filter-as-you-pour system configured to provide filtered water as water is poured from an outlet of the system, where the system includes a container body defining an internal storage volume, a lid that is releasably attachable over the container body, and a filter assembly. The lid may include an inlet through which unfiltered water may be directly introduced into the container body without passing through a filter. This advantageously provides for no fill delay as there is no delaying obstacle (e.g., a filter) between the inlet and the storage volume of the container body. The lid may also include an outlet through which water within the container body may be poured, the unfiltered water being simultaneously filtered as it is poured out of the container body through the outlet. The filter assembly may be configured as a vertical elongate filter assembly that is releasably attachable to the lid at a location that is aligned with and below the outlet, such that a longitudinal axis of the filter assembly is aligned with the outlet. The filter assembly is disposed over the outlet so as to prevent any bypass, so that all water poured through the outlet passes through the filter assembly.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary filter-as-you-pour pitcher system according to an embodiment of the present invention;

FIG. 2 is a schematic cross-sectional view through the system of FIG. 1 showing a flow path of water as it is introduced into the container of the system, as it flows into the filter housing, through the filter housing, and out the outlet of the system;

FIG. 3A is an exploded perspective view of an exemplary filter assembly such as that included in the system of FIG. 1;

FIG. 3B is an exploded perspective view of another exemplary filter assembly suitable for use with the present invention;

FIG. 4A is a perspective view of another exemplary pitcher system similar to that of FIG. 1, but employing the filter assembly of FIG. 3B;

FIG. 4B is an exploded perspective view of another exemplary container system, showing an embodiment with a combined inlet and outlet, which can filter the water upon both entry and exit;

FIGS. 5A-5B are exploded views showing yet another exemplary pitcher system, where the filter assembly is attached to the pitcher body, rather than the lid;

FIG. 5C is a cross-sectional view through a portion of the system of FIGS. 5A-5B, showing the filter assembly captured within and between the receptacle of the pitcher body and the lid placed over the pitcher body;

FIG. 6A is an exploded perspective view illustrating another exemplary embodiment of a filter-as-you-pour system;

FIG. 6B is an exploded perspective view illustrating another exemplary embodiment of a filter-as-you-pour system;

FIG. 6C is a cross-sectional schematic view through an assembled filter-as-you-pour system similar to that of FIG. 4B, showing the flow of water in and out of the system; and

FIG. 7 is a graph illustrating how free chlorine removal may decrease with increasing throughput.

### DETAILED DESCRIPTION

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Various aspects of the present devices and systems may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present.

Various aspects of the present devices, systems, and methods may be illustrated with reference to one or more exemplary embodiments. As used herein, the term “exemplary” means “serving as an example, instance, or illustration,” and should not necessarily be construed as preferred or advantageous over other embodiments disclosed herein.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentages (“wt %'s”) are in wt % (based on 100 weight % active) of the particular material present in the referenced composition, any remaining percentage typically being water or an aqueous carrier sufficient to account for 100% of the composition, unless otherwise noted. For very low weight percentages, the term “ppm” corresponding to parts per million on a weight/weight basis may be used, noting that 1.0 wt % corresponds to 10,000 ppm.

### II. Introduction

The present disclosure is directed to systems capable of filtering water as the water is poured from a container of the system. Such a system may include a container body defining an internal storage volume for holding water, a lid that may be releasably attachable over the container body, and a filter assembly (e.g., disposed within the container body). The system includes an inlet through which unfiltered water is introduced into the container body, and an outlet through which filtered water may be poured. The filter assembly may be attachable to at least one of the lid or the container body, and is disposed relative to the outlet so as to be in a flow stream of the water as the water is poured from the container. For example, the filter assembly may be disposed proximate the outlet (e.g., just upstream from the outlet). The filter media of the filter assembly may comprise an activated carbon fibrous textile material that presents a curved surface to the flow stream of water. The inventors have found that the activated carbon textile material, where arranged so as to present a curved surface to the water penetrating therethrough, surprisingly provides for relatively high flow rates (e.g., at least 0.3 GPM) while providing relatively high levels of contaminant removal, which makes possible the filter as you pour configuration from a practical perspective.

### III. Exemplary Systems

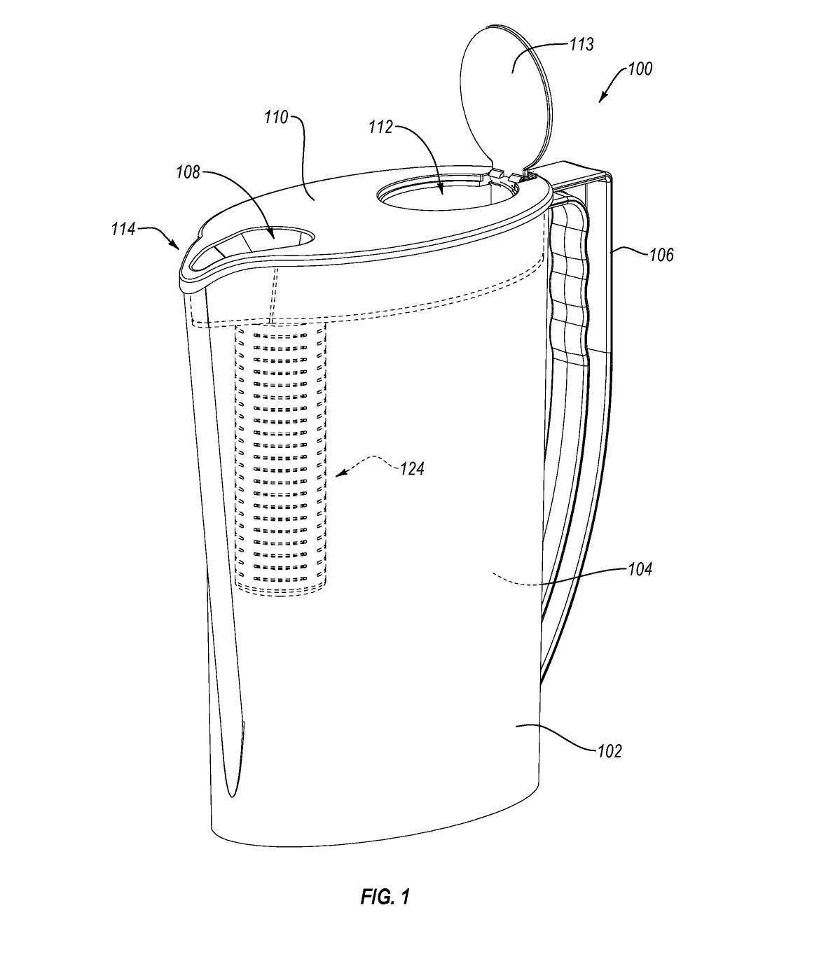

FIG. 1 show an exemplary system 100, which may operate as a filter-as-you-pour system. As illustrated, system 100 may include a container body 102 that defines an internal storage volume 104 for holding water (e.g., unfiltered water). As shown, container body 102 may include a handle 106 to aid in pouring water disposed within storage volume 104 out an outlet 108 of system 100. System 100 may further include a lid 110 that may be disposed over container body 102. Lid 110 may be releasably attachable relative to container body 102, e.g., it may include any suitable complementary locking structures disposed in lid 110 and/or container body 102 so as to allow lid 110 to be releasably attached or retained by container body 102. Friction fits between the two components, or any of various lock and key locking structures may be employed, e.g., so as to ensure that lid 110 does not inadvertently fall off of container body 102. Additional details of exemplary locking mechanisms are disclosed in a patent application bearing Clorox Docket No. 482.506, filed the same day as the present application and herein incorporated by reference.

Lid 110 may include an inlet 112, through which unfiltered water may be introduced into the container body 102. An inlet cover 113 may be provided. In an embodiment, outlet 108 may be defined within lid 110. In another embodiment, the inlet 112, outlet 108, or both may be defined within the container body 102. As illustrated in FIG. 1, container body 102 may be configured as a pitcher, e.g., including a spout 114, adjacent outlet 108. Spout 114, as illustrated, may be defined by structures in both container body 102 and lid 110. For example, container body 102 is shown as including a portion which tapers or narrows towards spout 114. Similarly, lid 110 is shown as including a corresponding cross-sectional shape, also being tapered at the portion corresponding to spout 114, so that lid 110 fits into the open top of container body 102. In addition, lid 110 is shown as including flared or tapered portions 116 adjacent outlet 108, providing a surface which slopes downward from a top of lid 110 to outlet 108. As a result, flared portion 116 defines a larger opening adjacent the top of lid 110, which slopes downward, much like a funnel, towards outlet 108.

In addition, in the illustrated embodiment, outlet 108 is shown as being disposed at the proximal end of spout 114, so that water exiting outlet 108 will flow along the tapered or narrowing spout portion 118 of lid 110, until it reaches the extreme end of spout portion 118, and exits the system 100 (e.g., into a glass, other container, etc.).

A flow control device 120 (e.g., a slit valve, grating or screen) may be disposed proximate outlet 108 (e.g., within outlet 108) to regulate an exit flow rate of water poured through outlet 108. For example, the flow control device may aid in ensuring that the exit flow rate of water from the system 100 is more consistent than might occur without such a flow control device. In addition, the flow control device may aid in ensuring that the flow rate is within a desired range of exit flow rates (e.g., from about 0.5 gallons per minute to about 0.8 gallons per minute). Further details of such flow control devices that may optionally be disposed within the system are disclosed in a patent application bearing Clorox Docket No. 482.514, filed the same day as the present application and herein incorporated by reference in its entirety.

System 100 further includes a filter assembly 124 that is attachable to lid 110, container body 102, or both lid 110 and container body 102. Filter assembly 124 is disposed within system 100 so as to be in a flow stream of the water as the water is poured from container body 102, through outlet 108. As a result, the stream of water exiting through outlet 108 is simultaneously filtered as it is poured from container body 102.

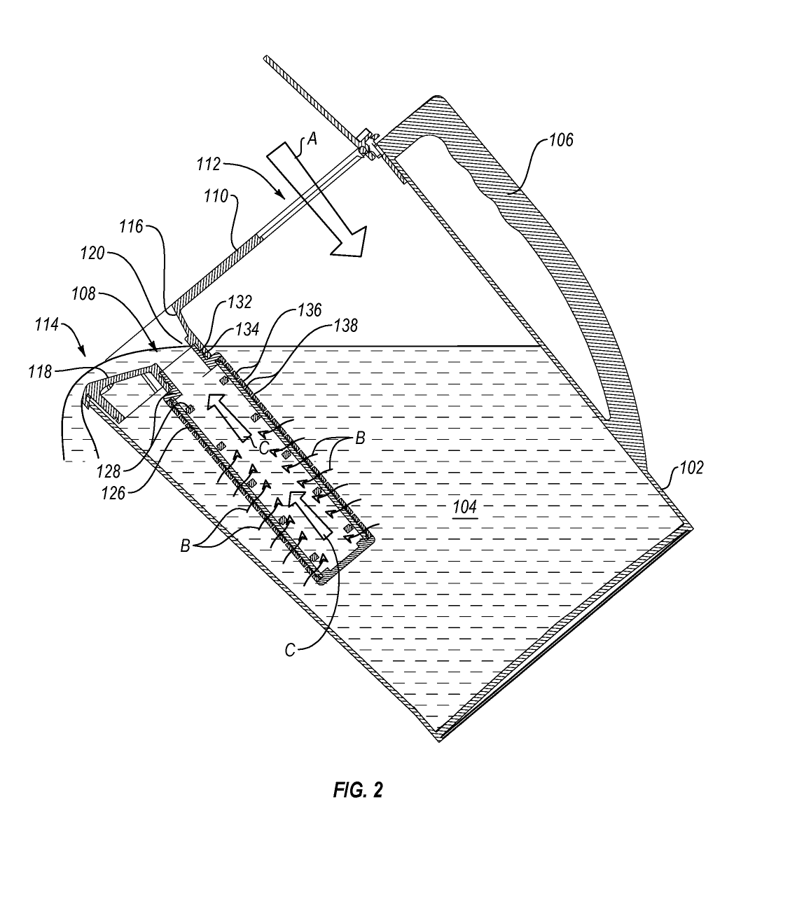

Filter assembly 124 may be releasably attachable to lid 110 through a thread and groove structural arrangement, e.g., so that assembly 124 may screw into lid 110, around or within outlet 108. In the illustrated embodiment, as perhaps best seen in cross-sectional view of FIG. 2, grooves 132 may be formed into the inside surface of outlet 108, with corresponding threads 134 formed into an exterior surface of the top end of filter assembly 124. Alternatively, the threads may be formed on the inside of outlet 108, and corresponding grooves formed into the exterior surface at the top of assembly 124. In another embodiment, the threads or grooves of outlet 108 could be disposed on an exterior surface of outlet 108, and the corresponding threads or grooves of filter assembly 124 could be disposed on an interior surface of the top end of the filter assembly, so that the filter assembly is releasably attachable over and about (e.g., surrounding) the outlet 108. The illustrated embodiment of FIG. 2 shows releasable attachment within outlet 108.

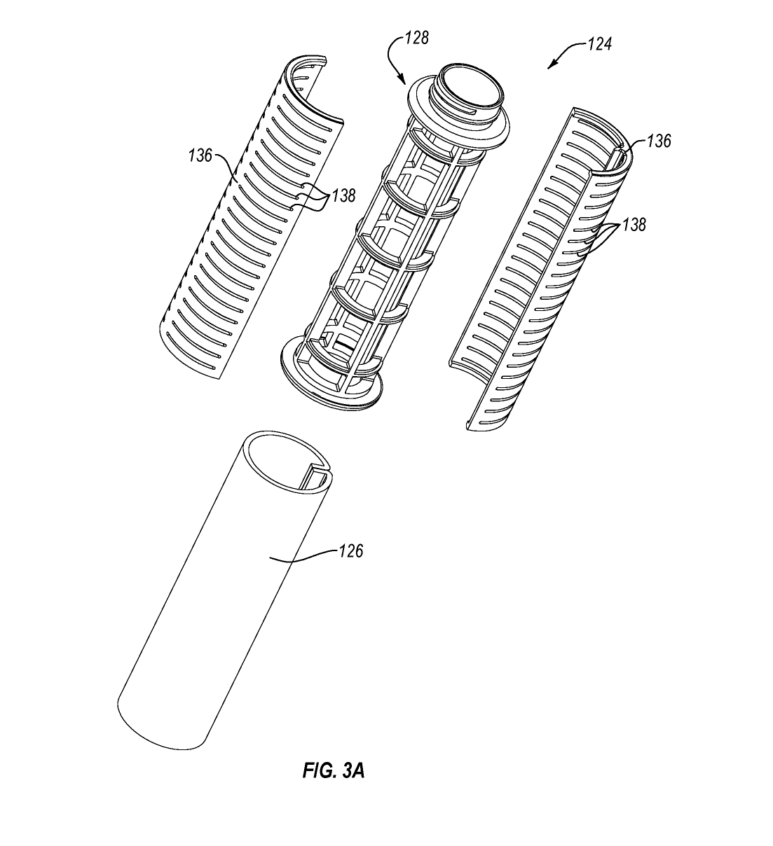

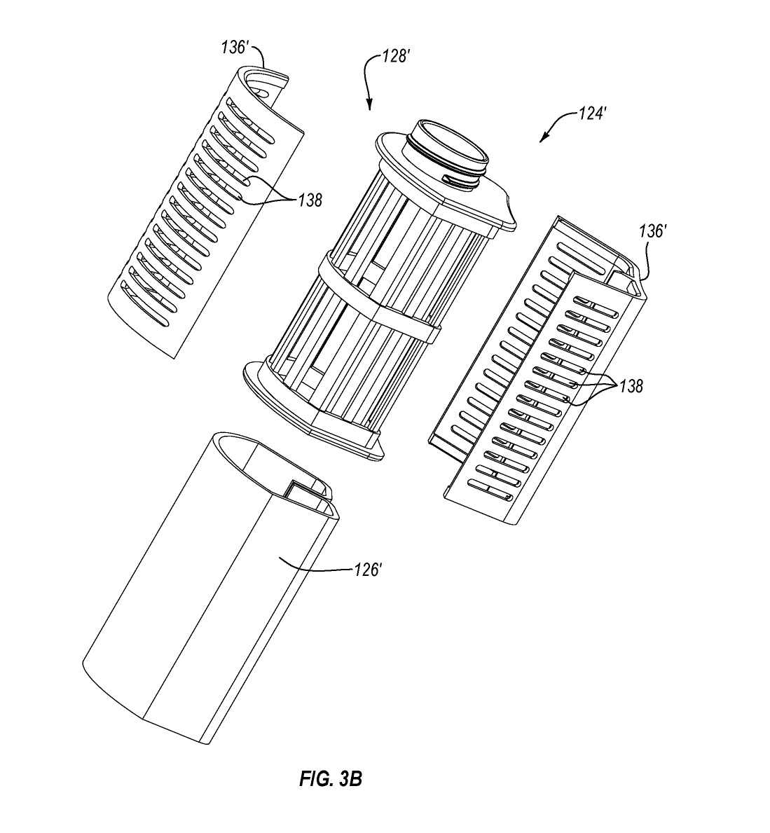

An exploded view of filter assembly 124 is shown in FIG. 3A, and assembly 124 is shown as being generally cylindrical, although it will be appreciated that other configurations may also be employed. In any case, the filter assembly may be configured to filter unfiltered water within container body 102 as it is poured therefrom, while at the same time providing a flow rate of water through outlet 108 that is at least about 0.3 gallons per minute (GPM). In another embodiment, the flow rate may be at least about 0.5 GPM. In an embodiment, the filter assembly is advantageously configured to provide and allow for exit flow rates from about 0.3 GPM to about 2 GPM, from about 0.3 GPM to about 1 GPM, or from about 0.5 GPM to about 0.8 GPM. Such flow rates are typically not possible with filter assemblies including granulated, particulate filter media typically employed in gravity fed or gravity flow water filtration systems that include a reservoir into which unfiltered water is introduced, which water then trickles through the filter assembly and into the container body (e.g., pitcher), where it can then be poured therefrom. For example, filter assemblies based on such filter media typically require 3 to 8 minutes to filter 1 liter of water (e.g., flow rates of 0.03 GPM to 0.09 GPM). In an embodiment, the present systems may not include any such reservoir.

The filter assemblies employed in the present invention may advantageously provide for much faster filtration flow rates, such as those above. In an embodiment, the filter media of the filter assembly comprises an activated carbon textile material (i.e., such a textile material is fibrous), which textile material is arranged within the filter assembly so as to present a curved surface to the flow stream of water. Such textile materials disposed so as to present a curved surface to the flow stream of water have surprisingly been found to provide and allow for significantly faster flow rates as compared to the 3 to 8 minutes to filter 1 liter. For example, exit flow rates may be from about 0.3 GPM to about 2 GPM or 0.3 GPM to about 1 GPM.

The textile material may be formed from structural elements selected from the group consisting of fibers, yarns, filaments, flexible porous composites, combinations thereof, etc., which may be woven, non-woven, braided, or otherwise joined into a textile material. Such textile materials may typically be comprised of relatively high aspect ratio structural elements whose length is orders of magnitude (e.g., 1-5 orders of magnitude) larger than the diameter.

Such textile materials also may have varying degrees of structural integrity based on the amount, size, and distribution of the structural elements. For example some textile structures may have the structural elements loosely held generally parallel to each other while in other embodiments the structural elements may be twisted around a longitudinal axis or they may be interlaced orthogonally relative to each other or they may be randomly oriented relative to each other. The physical dimensions and orientation of the structural elements of the textile material also create a depth to thickness ratio for the resulting textile material, along with pores of various sizes.

For best use in water filtration applications these textile materials preferably may have an optimal combination of thickness and pore size distribution to not only allow water to flow at the desired flow rate, but also contain enough mass of material to enable desired levels of contaminant reduction, while having enough physical integrity to prevent the structural elements the textile material is made of from being dislodged by the water penetrating through it.

By way of non-limiting example, a textile material employed as filter media may have properties as shown in Table 1 below.

TABLE l

| Property | Specification | |
|---|---|---|
| Basis Weight | 25-200 | g/m² |
| Thickness | 0.5-5.0 | mm |
| Iodine Number | 500-3000 | mg/g |
| Pore size distribution (avg.) | 5-1000 | μm |
| Fiber diameter (avg.) | 1-50 | μm |

Exemplary textile materials may have a thickness from about 0.5 mm to about 2 mm (e.g., about 0.75 mm to about 1 mm). The fibers of the textile material may have any suitable diameter, e.g., from about 0.1 μm to about 50 μm, from 0.1 to about 20 μm, etc. It is believed that the fibrous characteristics of the textile material from which the filter media is formed may be at least in part responsible for the relatively high flow rates. Such characteristics are believed to exhibit higher ratios of surface area to volume than possible with filter media foam substrates, providing superior filtration effectiveness characteristics than possible with a single pass through a typical foam filter media material. For example, the efficiency available with a foam filter media may be only about ⅓ that provided by granulated activated carbon filter media, under typical use conditions. Such textile materials also provide lower flow resistance than available when using granulated activated carbon filter media, making possible the desired relatively high flow rates. Thus, the described textile materials arranged as described herein provide for relatively high flow rates and relatively high rates of effectiveness in contaminant removal.

For example, such foam filter systems are not particularly efficient in removing chlorine or other contaminants, as relatively more foam material is required to achieve a desired target removal efficiency. The activated carbon textile materials as employed herein advantageously are capable of achieving contaminant removal efficiencies (e.g., at least 80%, at least 85%, at least 90%, at least 95%, or at least 99% chlorine removal) comparable to that achieved by products employing monolithic or granulated activated carbon filter media, but at flow rates that are significantly higher than provided with granulated or monolithic activated carbon, and that are relatively small in size, making practical the implementation of a filter-as-you-pour container system.

Stated another way, the filter-as-you-pour systems of the present invention employ a textile filter media material arranged so as to present a curved surface to inflowing water to be filtered. The configurations allow for relatively compact filter assemblies capable of providing performance equivalent or similar to larger (e.g., greater surface area of filter media) or multi-stage systems. The filter-as-you-pour system places textile filter media material in the path of water flowing out from the container body under gravity-flow conditions. Under such conditions, with a known porous filter material constant bulk density, Darcy's law applies:

$$k = \frac{QL μ}{ρ gA Δ P}$$

| | | Typical Units | Typical Operating | |
|---|---|---|---|---|
| Symbol | Variable | Metric (English) | Range | |
| k | Intrinsic | cm/s (ft/s) | 1.2 × 10⁻⁷-3.7 × 10⁻⁴ | |
| | Permeability | | (4 × 10⁻⁹-1.2 × 10⁻⁵) | |
| Q | Flow Rate | L/min (gal/min) | 0.75-7.5 | (0.2-2.0) |
| L | Path Length | cm (in) | 0.1-0.5 | (0.04-0.2) |
| μ | Dynamic | g/cm-s (lbf/ft-s) | 0.9-1.4 | (0.06-0. |
| | Viscosity | | | |
| ρ | Fluid Density | g/cm³ (lb/ft³) | 1.00 | (62.4) |
| G | Gravity | cm/s² (ft/s²) | 980.665 | (32.174) |
| | Acceleration | | | |
| A | Surface Area | cm2 (ft²) | 50-650 | (0.05-0.60) |
| ΔP | Pressure | cm H₂O (lb/in²) | 5-15 | (0.07-0.22) |
| | Differential | | | |

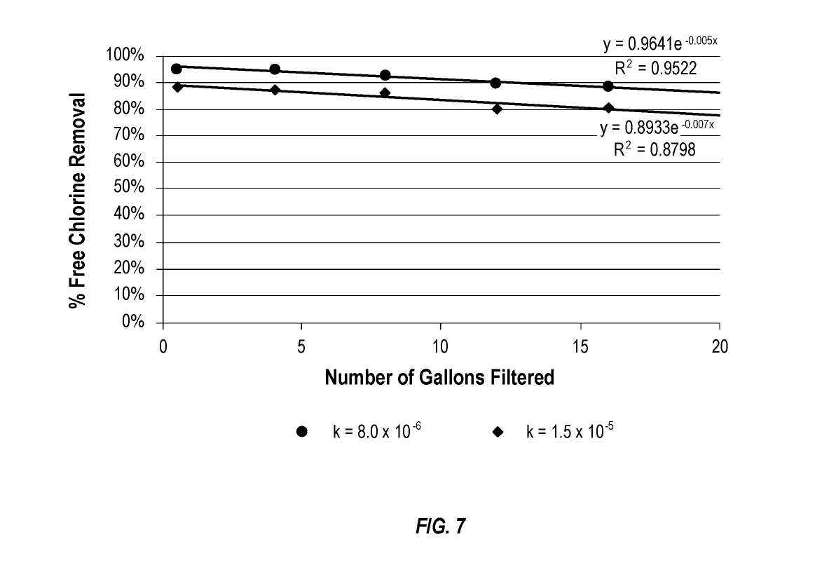

For a given filter material density and associated permeability, the removal efficiency for a given water contaminant (e.g., chlorine) can be related directly to the mass load of that constituent over time. For a constant influent concentration (e.g., the unfiltered water all includes the same chlorine concentration), removal efficiency can be related to total flow throughput. For a first-order reaction, such as that characteristic of free chlorine degradation or adsorption on activated carbon, this follows an exponential curve. As permeability increases, contaminant removal decreases. The filter-as-you-pour configuration and textile filter media material described has the advantage of providing higher contaminant removal efficiency at higher permeability than alternative methods. Because of these advantages, this allows relatively smaller filtration assemblies, and/or better removal efficiencies. FIG. 7 illustrates exemplary contaminant removal profiles for two different permeability values over a portion of the life of a filter assembly.

Such filter assemblies may have a life of at least about 20 gallons, at least about 30 gallons, at least about 40 gallons, from about 40 to about 80 gallons, etc. At the end of its life the filter assembly may still achieve chlorine removal of at least 60%, at least 70%, or at least 75%. The filter assemblies may meet applicable NSF/AISI 42 standards. As shown in FIG. 7, the contaminant removal efficiency may be relatively consistent over the life of the filter assembly (e.g., within ±30%, within ±25%, within ±20%, within ±10%, or within ±5% of a lifetime average removal efficiency.

FIG. 3A illustrates an exploded view of filter assembly 124. The textile material 126 may comprise one or more layers that are wrapped around a core frame member 128 of the filter assembly 124, so that the flexible, fibrous textile material presents a curved surface to water entering the filter assembly 124. Assembly 124 is shown (FIG. 1) as being mounted generally vertically within storage volume 104 (e.g., attached to lid 110). A casing or shell 136 may be disposed about core frame member 128, sandwiching textile material 126 between shell 136 and core frame member 128. As shown, shell 136 may include slots 138 disposed therein, so as to allow water that is to be filtered by assembly 124 to enter.

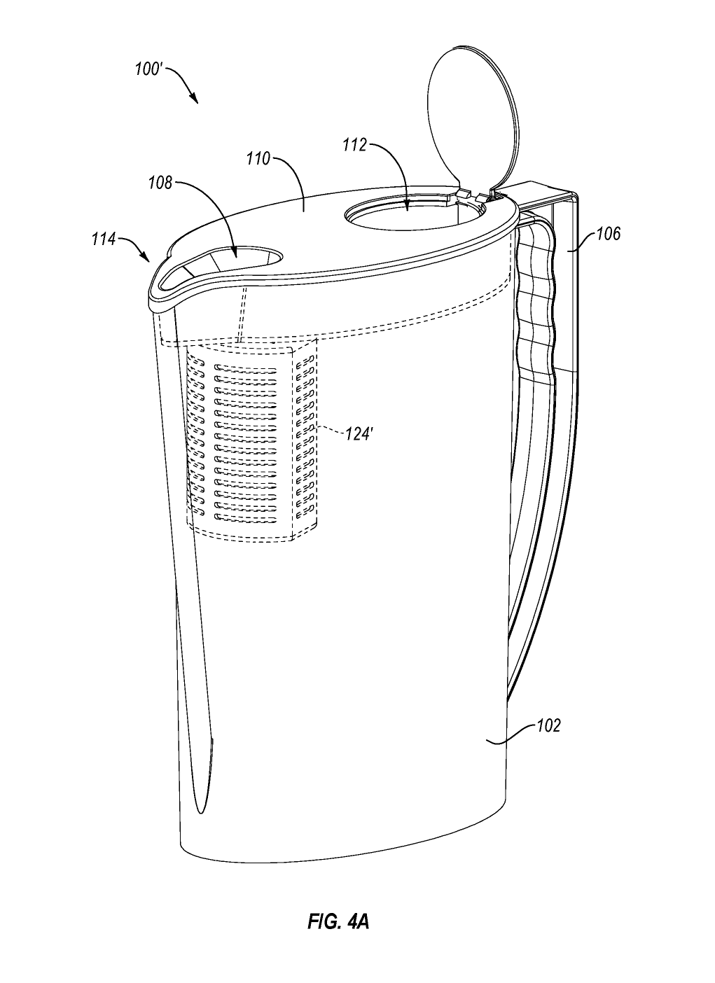

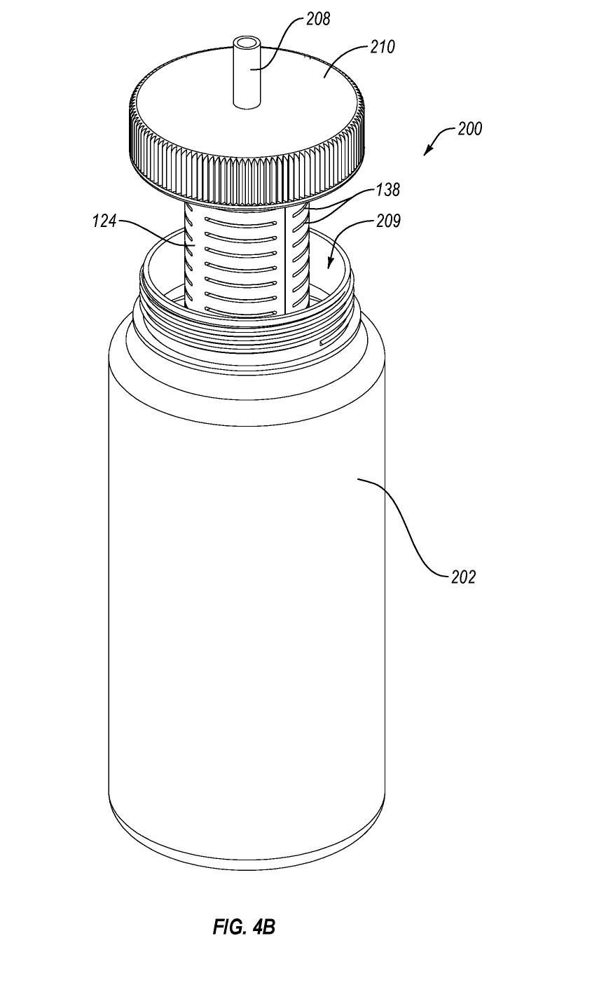

FIG. 2 illustrates an exemplary flow path along which the water may pass as it moves through system 100, including assembly 124. For example, water may be introduced into container body 102 through inlet 112 in lid 110, as depicted by arrow A. As shown, advantageously, no filter may be disposed between inlet 112 and storage volume 104, so that unfiltered water may be quickly introduced into container body 102, without any delay associated with a filter disposed between inlet 112 and storage volume 104. Rather than filtering upon entering container body 102, at least some embodiments of the present invention provide for filtering of the water only as it exits through outlet 108. Of course, some embodiments may provide filtering upon entrance and exit, if desired (e.g., where the inlet and the outlet are one and the same). FIG. 4B, described below, illustrates one such embodiment.

When tipping pitcher or other container body 102 (e.g., as depicted in FIG. 2), the water may flow along a radial flow path B, through one or more layers of fibrous textile filter media 126, which advantageously is disposed so as to present a curved, rather than perpendicular or planar surface to the stream of water. By positioning fibrous, textile filter media 126 so that at least a portion thereof presents a curved, rather than planar surface, the inventors have surprisingly found that flow rates through the filter media are significantly increased. Once the water passes through layer(s) 126, the filtered water may then flow axially, as represented by arrows C, up towards outlet 108. The filtered water may pass through outlet 108, and over spout portion 118 of lid 110.

In an embodiment, characteristics of textile filter media material 126 may also be adjusted to alter the flow characteristics of the stream of water exiting the system, e.g., in combination with any flow control device disposed proximate the outlet (e.g., outlet 108). For example, in an embodiment, the filter media 126 may comprise a single layer of the activated carbon textile material. In another embodiment, a second layer may be provided, so that the filter media comprises two layers of activated carbon textile material (e.g., two layers, each about 0.75 mm to about 1 mm in thickness). Similar results may be achieved by increasing the thickness of a single textile layer (e.g., about 1.5 mm to 2 mm rather than a 0.75 mm to 1 mm thick single layer). Providing two layers of textile filter media material 126 (or a thicker single layer) may reduce the flow rate of water through the system as compared to a single layer of a given thickness.

Use of two layers may also increase the filtration effectiveness characteristics (e.g., a higher fraction of removed chlorine), e.g., where the layers are configured to remove the same materials) or increase life (e.g., gallons filtered before recommended filter replacement). For example, use of two layers may flatten the curve resulting from a plot of chlorine removal versus gallons filtered (see FIG. 7), providing increased consistency over the life of the filter. In addition, the second layer may be differently configured relative to the first layer, so as to remove different contaminants. For example, a second layer may comprise an ion exchange resin (IER) in fibrous, textile form, so as to be disposed within filter assembly 124 in a similar manner as the activated carbon textile material 126, but capable of removing heavy metal contaminants (e.g., copper, cadmium, mercury, lead, etc.).

The activated carbon textile material 126 is fibrous, e.g., so that fibers, filaments, or other structural elements of the material may be matted, woven, braided, or otherwise joined together. Such a fibrous material exhibits very high porosity characteristics, allowing and providing for the relatively high flow rates of water therethrough, as described herein. Such porosity and associated flowrate characteristics are not possible with traditionally employed filter media, such as monolithic activated carbon block, or a bed of activated carbon granules or particles. Although filtering foam filter media may offer gravity fed flow rates therethrough that are higher than those possible with granulated or monolithic activated carbon, it does not provide as high a degree of contaminant removal with a single pass as provided by monolithic or granulated activated carbon (e.g., about 99% chlorine removal), under typical use conditions. In other words, such foam filter systems are not particularly efficient in removing chlorine or other contaminants. For example, foam filter media (e.g., such as that employed in the CAMBELBAK RELAY) may remove only about ⅓ as much chlorine in a single pass under typical use conditions. As a result, products relying on filtration using a foam filter media may typically pass the water through the foam filter media both upon entry and exit from the container in order to achieve an acceptable level of contaminant removal efficacy. Even after two such passes, the level of chlorine removal may be less than that provided by granulated or block activated carbon filter media.

Employing the fibrous activated carbon textile material as described herein advantageously is capable of achieving contaminant removal efficacy (e.g., at least 80%, at least 85%, at least 90%, at least 95%, or at least 99% chlorine removal) that is comparable to that achieved by products employing monolithic or granulated activated carbon filter media (e.g., about 3 times greater than that provided by foam), but at flow rates that are significantly higher (e.g., at least about 0.3 GPM) than granulated activated carbon, which makes practical implementation of a filter-as-you-pour container system possible. For example, such percentages as described above of the chlorine present (e.g., as added to typical residential drinking supplies) may be removed by the textile filter media 126, in a single pass. In addition, other contaminants (e.g., heavy metals) may be removed where the filter assembly further comprises an ion exchange resin (IER) section. For example, such an IER section may comprise a second layer of textile material, or may be disposed in the central hollow core defined by frame member 128 (see FIG. 3A).

FIG. 3B illustrates another filter assembly configuration 124′, where the front face of filter assembly 124′ is curved, and FIG. 4A shows an exemplary system 100′ including filter assembly 124′. Such a filter assembly 124′ includes a transverse cross-section that is generally 4-sided, wherein the front side of the quadrilateral is crescent shaped, providing the desired curved surface. System 100′ may be otherwise similar to system 100 of FIG. 1, including a core frame 128′ about which textile filter media material 126′ is wrapped, with casing or shell portions 136′ disposed thereover. It will be readily apparent that various filter assembly configurations may be employed. Additional details of exemplary filter assemblies, filter media and filter housings are disclosed in U.S. patent applications bearing Clorox Docket No. 482.508; Clorox Docket No. 482.510; and Clorox Docket No. 482.512, each filed the same day as the present application and each herein incorporated by reference in its entirety.

FIG. 4B illustrates an embodiment of a system 200 including a lid 210, a container body 202, and a filter assembly 124, where filtering may be achieved both upon entry and upon exit. Filter assembly 124 may be similar or identical to the cylindrical filter assembly 124 shown in FIGS. 1-3A. Rather than including separate inlets and outlets, system 200 includes a single combined inlet and outlet 208. Lid 210 and the top of container body 202 may collectively comprise a mating thread and groove attachment mechanism by which lid 210 is releasably attachable over container body 202. Filter assembly 124 may be releasably attached into the underside of lid 210, by a mechanism similar to the threaded attachment shown and described above in conjunction with FIGS. 1-3A.

As a combined inlet and outlet 208 is provided, water may be filtered both on entry and on exit to and from container body 202. For example, water may be introduced through opening 208, along a flow path that is opposite that shown in FIG. 2. For example, the introduced water may flow downward (e.g., in a direction opposite arrows C of FIG. 2). This portion of the flow path may be axial relative to the longitudinal axis of filter assembly 124. The water may then flow in a direction opposite that of arrows B, through the textile filter media material 126, exiting slots 138. This portion of the flow path may be radial relative to the longitudinal axis of filter assembly 124. Having passed through filter assembly 124 once, and now in container body 202, the flow path of the water upon exiting through combined inlet and outlet 208 may be opposite to that just described—i.e., the same flow path as described above in conjunction with FIG. 2. In other words, during exit, the flow path may initially be radial as the water penetrates through textile filter media material 126 (which is curved relative to the penetrating water), as represented by arrows B. The flow within the central portion of filter assembly 124 may then be axial, as represented by arrows C as the water progresses towards and out combined inlet and outlet 208.

Of course, one may remove the lid 210 when filling container body 102, so as to filter only upon pouring (i.e., water enters directly into the open top 209 of container body 202, without passing through combined inlet and outlet 208). Similarly, one may filter upon entrance, and then remove the lid 210 and drink or otherwise pour the filtered water within container body 202, without having it pass again through the combined inlet and outlet 208.

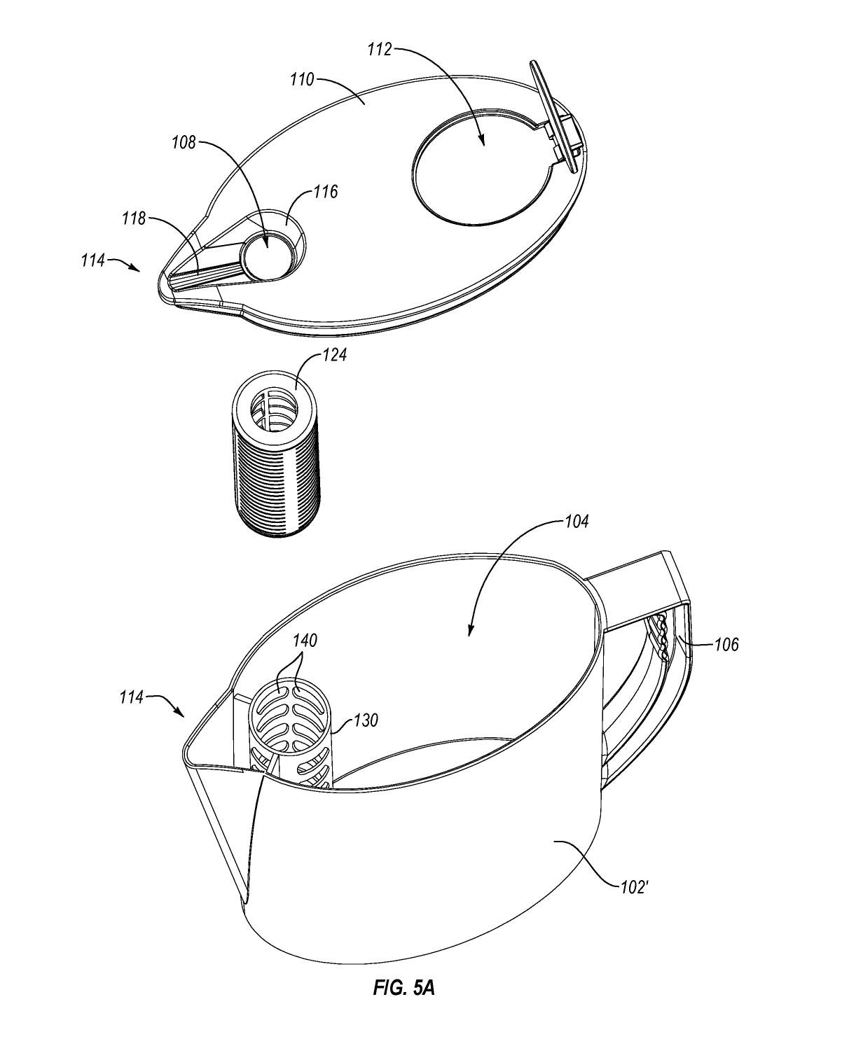

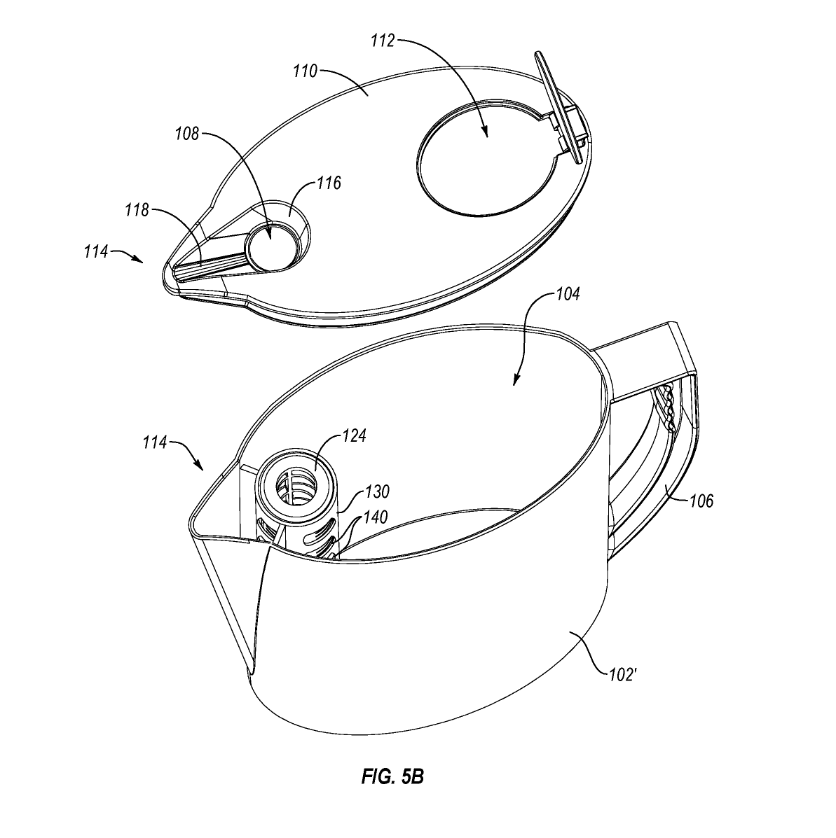

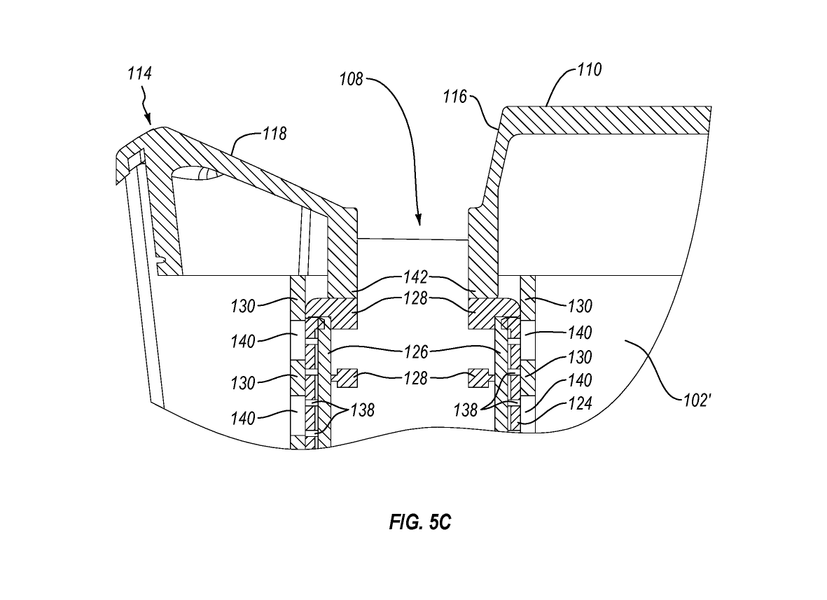

The filter assemblies 124 and 124′ of FIGS. 1, 4A, and 4B are shown as attached to lid 110 or lid 210 (e.g., through any suitable releasable attachment mechanism, such as the illustrated threaded connection, a friction fit, etc.). In another embodiment, the filter assembly may be releaseably attached or disposed within structure of the container body of the system. FIGS. 5A-5C illustrate such an exemplary configuration, where container body 102′ may include a receptacle 130 into which the filter assembly (e.g., assembly 124) may be received. Receptable 130 of container body 102′ may include slots 140 disposed therein to allow water within storage volume 104 to pass through the wall of receptable 130, into slots 138 of filter assembly 124. Water may flow through filter assembly 124 in a similar manner as described in conjunction with FIG. 2.

In an embodiment, the filter assembly is elongate and generally vertically oriented relative to the lid (e.g., lid 110 or 210) when horizontal (e.g., as depicted in FIG. 1, 4A or 4B). In an embodiment, the filter assembly may be generally cylindrical, with the textile material 126 arranged in a generally cylindrical shape, such as depicted in FIG. 3A. In an embodiment, the filter assembly, the cylindrical shape of the textile material 126, or both, may have a length to width ratio of at least 1:1, at least 2:1, or at least 3:1 (e.g., about 2:1 to about 4:1). For example, in an embodiment, the length of the filter assembly may be about 110 mm, and the diameter, about 36 mm (e.g., providing a ratio of length to width of about 3:1). The crescent shaped filter assembly of FIG. 3B may have similar length to width ratios, as described in U.S. patent applications bearing Clorox Docket No. 482.508; Clorox Docket No. 482.510; and Clorox Docket No. 482.512, already incorporated by reference.

As seen in FIGS. 5B and 5C, filter assembly 124 may drop down into receptacle 130, and be retained therein once lid 110 is placed over the open top of container body 102′. Outlet 108 through lid 110 may be axially aligned with the longitudinal axis of generally vertical cylindrical filter assembly 124, so that water within the hollow central core of assembly 124 flows axially upward, towards outlet 108. A seal or other barrier may be provided between the top of receptacle 130 and the bottom of outlet 108 to minimize any risk of bypass, by which water could exit through outlet 108 without first passing through filter assembly 124. FIG. 5C illustrates such a feature, as a sealing extension 142 which extends downwardly from outlet 108, into or about the top of receptacle 130. Such an extension may press against the top of assembly 124 and/or receptacle 130, so as to also minimize or prevent axial translation of assembly 124 within receptacle 130, which may otherwise occur where assembly 124 is merely trapped rather than directly attached to the lid or container body. Of course, in an embodiment, assembly 124 could also screw into or otherwise releasably attach to lid 110. Similarly, assembly 124 could screw into or otherwise releasably attach to receptacle 130 (e.g., the bottom of receptacle 130), if desired.

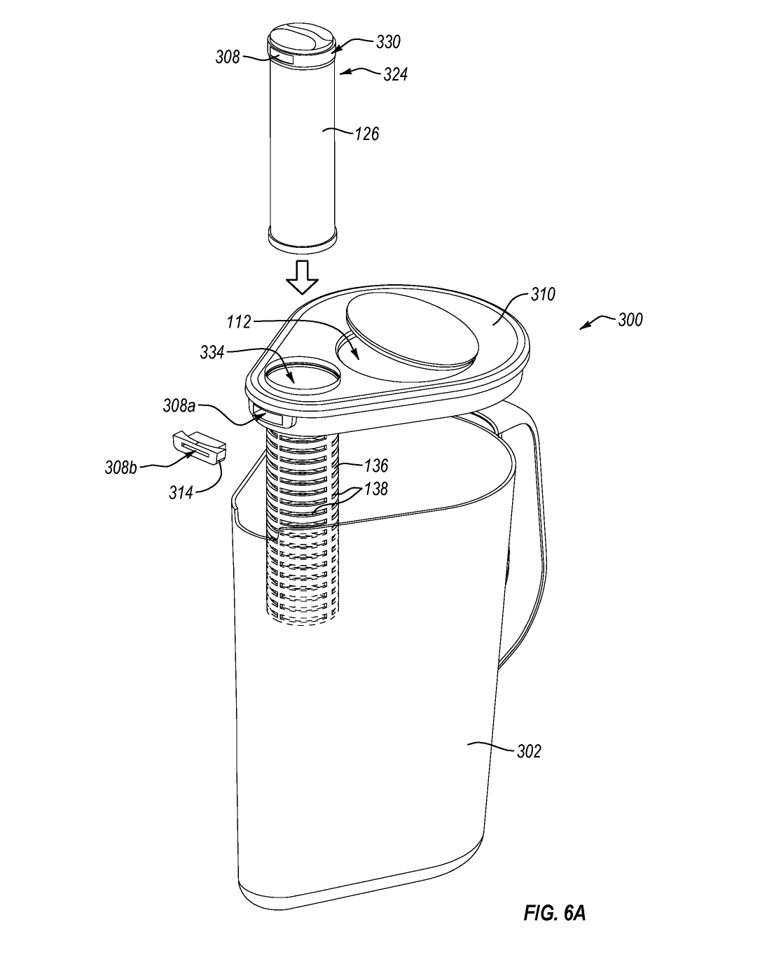

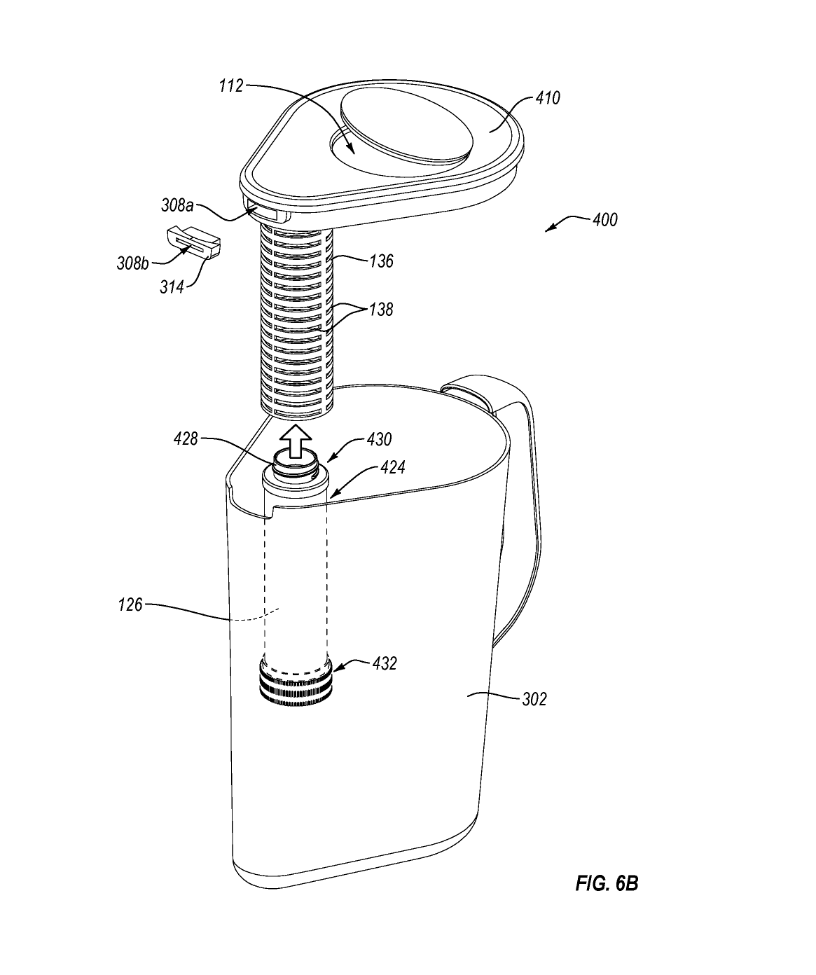

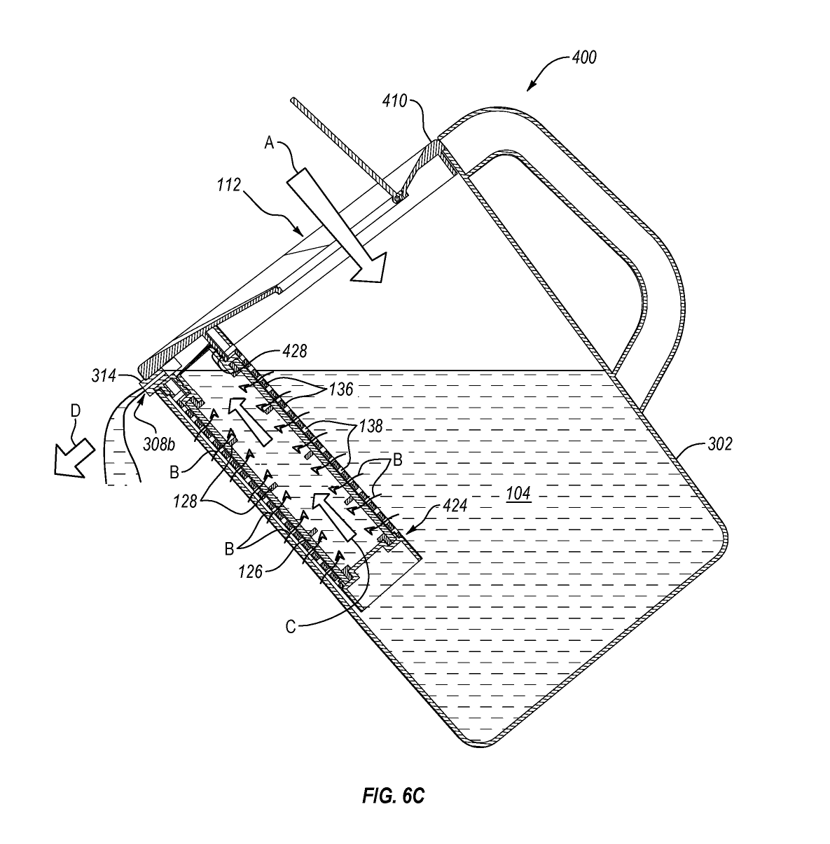

FIGS. 6A-6B illustrates an exemplary configuration where the filter assembly may be inserted from the top down, or from the bottom up, respectively. Both configurations shown in FIGS. 6A-6B include a particular lid and spout configuration that permit exiting water to flow out of the system in a direction that is radial relative to the filter assembly. FIG. 6C illustrates a cross-section through the system of FIG. 6B.

As seen in FIG. 6A, a system 300 may include a container body 302, a lid body 310, and a filter assembly 324, which may be inserted from the top down (e.g., dropped down) into casing or shell 136, which includes slots 138. Filter assembly 324 may be trapped between a bottom of casing or shell 136 and lid body 310, upon insertion therein. For example, a top end of filter assembly 324 may snap into or otherwise be secured into lid body 310. A top end of shell 136 may be threaded, snapped, or similarly secured into lid body 310. In another embodiment, the filter assembly 324 could be screwed or similarly secured (e.g., snapped) into a bottom of shell 136, etc. An opening 334 not for exit of filtered water, but for insertion of filter assembly 324 may be provided (e.g., towards the forward end of) in lid body 310. Opening 334 is plugged or sealed upon insertion of filter assembly 324 into shell 136.

Filter assembly 324 may be similar to assembly 124 of FIG. 3A, e.g., including a core about which textile filter media material 126 is wrapped, providing a generally cylindrical shape. The top end 330 of filter assembly 324 may be somewhat differently configured than assembly 124, e.g., so as to provide for exit of filtered water in a radial or lateral direction, rather than coaxial with the longitudinal axis of the assembly 324. For example, within the interior of filter assembly 324, the top end 330 may be closed, while outlet 308 for exiting filtered water may be provided in a lateral side of top end 330 of filter assembly 324. A corresponding outlet portion 308a may also be provided in lid body 310, in-line with outlet 308 of filter assembly. So that filtered water exiting filter assembly 324 through outlet 308 then enters outlet portion 308a of lid body 310. A spout 314 may be inserted including another outlet portion 308b may be inserted and retained within outlet portion 308a, so that filtered water exiting outlet 308 flows through outlet portions 308a and 308b, then exiting the system 300.

Spout 314 may be configured (e.g., in cross-sectional area, other geometric characteristics, etc.) to serve as a flow control device, to regulate flow out of system 300 to a desired flow rate, as described herein. Spout 314 may redirect filtered water flow exiting axially from the filter assembly, and may control and ensure water exits along a guided flowpath. The interior pathway defined by spout 314 (e.g., outlet 308, 308a, and to 308b) may be tapered in cross-sectional area and/or width, narrowing towards exit 308b. Such a spout 314 has been found to be helpful in providing consistent flow rates over the volume of water dispensed by the container body (e.g., so that the flow rate when dispensing the first cup from a full container is substantially equal to the flow rate when dispensing the last cup from a nearly empty container. For example, flow rates may be within ±30%, ±25%, ±20%, ±10%, or ±5%, over the entire volume of the container. Additional details of such flow regulation are described in Clorox Docket No. 482.514, already incorporated by reference.

FIG. 6B illustrates a similar system 400 including a lid body 410 to which shell 136 may be secured. In the embodiment seen in FIG. 6B, filter assembly 424 may also be similarly configured to filter assembly 124, e.g., including a core about which textile filter media material 126 is wrapped, providing a generally cylindrical shape. Rather than being inserted from above as in FIG. 6A, the filter assembly 424 may be inserted into shell 136 from below. As shown, a top end 430 of filter assembly 424 may include threads 428 for threading filter cartridge 424 into corresponding grooves of lid body 410. Alternatively, top end 430 could snap into lid body 410. The bottom end 432 of filter assembly 424 may be provided with a ribbed outer surface to facilitate screwing of filter assembly 424 into lid body 410.

A spout 314 similar to that described in conjunction with FIG. 6A may also be provided, inserted within an outlet portion 308a in lid body 410, so that water exits system 400 through outlet 308b in a direction that is radial or lateral relative to the longitudinal axis of filter assembly 424 received within shell 136. For example, both FIGS. 6A and 6B illustrate configurations in which the water enters through an inlet 112 in a top of the lid body, but in which water exits the system in a lateral, perpendicular direction, rotated about 90° relative to inlet 112, rather than exhibiting an inlet and outlet that are parallel to one another (e.g., inlet 112 and outlet 108 of FIG. 1 are parallel to one another, while inlet 112 and outlet 308b of FIGS. 6A-6B are perpendicular to one another).

FIG. 6C shows a cross-sectional view through the assembled system 400 of FIG. 6B illustrating an exemplary flow path, similar to that shown in FIG. 2. The system 300 of FIG. 6A may include a similar flow path as that shown in FIG. 6C. As shown, unfiltered water may be introduced into container body 302 through inlet 112 (arrow A), flow into filter assembly 424 along a radial flow path as depicted by arrows B, through one or more layers of textile material filter media 126, which advantageously is disposed so as to present a curved, rather than perpendicular or planar surface to the stream of water. Once the water passes through layer(s) 126, the filtered water may then flow axially, as represented by arrows C, up towards outlet 308b. In order to exit outlet 308b, the filtered water is again turned, flowing laterally outward (arrow D). Before finally exiting outlet 308b, the filtered water may pass through any additional flow control device (e.g., a slit valve, grating, etc.) disposed adjacent the outlet.

Various other features of exemplary systems may be disclosed in one or more of the following patent applications, each filed the same day as the present application and herein incorporated by reference: Clorox Docket No. 482.506; Clorox Docket No. 482.508; Clorox Docket No. 482.510; Clorox Docket No. 482.512; Clorox Docket No. 482.514; and Clorox Docket No. 482.516.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

1. A filter-as-you-pour system configured to provide filtered water as water is poured from an outlet of the system, the system comprising:
a container body defining an internal storage volume for holding water;
a lid that is releasably attachable over the container body;
the system comprising an inlet through which unfiltered water may be introduced into the container body;
the system comprising an outlet through which water within the container body may be poured and simultaneously filtered;
a filter assembly attachable to at least one of the lid or the container body, the filter assembly being disposed so as to be in a flow stream of the water as the water is poured out of the container body through the outlet so that the stream of water exiting through the outlet is simultaneously filtered as it is poured from the container body, the filter assembly including filter media that comprises an activated carbon textile material that presents a curved surface to the flow stream of water such that an exit flow rate of water passing through the filter assembly and poured from the outlet is at least 0.3 GPM.

2. The filter-as-you-pour system of claim 1, wherein the exit flow rate of the water is from about 0.3 GPM to about 2 GPM.

3. The filter-as-you-pour system of claim 1, wherein the exit flow rate of the water is from about 0.3 GPM to about 1 GPM.

4. The filter-as-you-pour system of claim 1, wherein the exit flow rate of the water is from about 0.5 GPM to about 0.8 GPM.

5. The filter-as-you-pour system of claim 1, wherein the container body does not include a reservoir for holding unfiltered water separate from the internal storage volume of the container body.

6. The filter-as-you-pour system of claim 1, wherein the filter assembly is elongate and generally vertically oriented relative to the lid when horizontal, the filter assembly having a length to width ratio of at least 1:1.

7. The filter-as-you-pour system of claim 6, wherein the filter assembly is generally cylindrical, and includes a length to diameter ratio of at least 2:1.

8. The filter-as-you-pour system of claim 6, wherein the filter assembly includes a transverse cross-section that is generally 4-sided, wherein one of the sides of the 4-sided cross-section is crescent shaped.

9. The filter-as-you-pour system of claim 6, wherein the vertically oriented elongate filter assembly is releasably attachable to the lid at a location that is aligned with and below the outlet such that a longitudinal axis of the filter assembly is aligned with the outlet, all water poured through the outlet passing through the filter assembly so that water poured through the outlet is simultaneously filtered as it is poured from the container body.

10. The filter-as-you-pour system of claim 1, wherein the filter assembly is releasably attachable to the container body.

11. The filter-as-you-pour system of claim 1, wherein the system is configured to filter water only as water is poured out of the container body.

12. The filter-as-you-pour system of claim 1, wherein the inlet is disposed in the lid.

13. The filter-as-you-pour system of claim 1, wherein the outlet is disposed in the lid.

14. The filter-as-you-pour system of claim 1, wherein both the inlet and the outlet are disposed in the lid.

15. The filter-as-you-pour system of claim 1, wherein the filter assembly is a gravity flow filter.

16. A filter-as-you-pour system configured to provide filtered water as water is poured from an outlet of the system, the system comprising:
a container body defining an internal storage volume;
a lid that is releasably attachable over the container body, the lid including:
an inlet through which unfiltered water may be directly introduced into the container body without passing through a filter;
an outlet through which water within the container body may be poured, the unfiltered water being simultaneously filtered as it is poured out of the container body through the outlet; and
a vertically oriented elongate filter assembly releasably attachable to the lid at a location that is aligned with and below the outlet such that a longitudinal axis of the filter assembly is aligned with the outlet, all water poured through the outlet passing through the filter assembly so that water poured through the outlet is simultaneously filtered as it is poured from the container body.

17. The filter-as-you-pour system of claim 16, wherein an exit flow rate of the water as water is poured from the container body through the outlet is at least 0.3 GPM.

18. The filter-as-you-pour system of claim 16, wherein filter media of the filter assembly comprises an activated carbon textile material that presents a curved surface to the flow stream of water.

19. The filter-as-you-pour system of claim 16, wherein the filter assembly is elongate and generally vertically oriented relative to the lid when horizontal, the filter assembly having a length to width ratio of at least 1:1.

20. The filter-as-you-pour system of claim 19, wherein the filter assembly is generally cylindrical, and includes a length to diameter ratio of at least 2:1.
